(19) United States
(12) Patent Application Publication
(10) Pub. No.: US 2014/0222596 A1
(43) Pub. Date: Aug. 7, 2014

(54) SYSTEM AND METHOD FOR CARDLESS FINANCIAL TRANSACTION USING FACIAL BIOMERTICS

(71) Applicant: NITHIN VIDYA PRAKASH S, COONOOR (TN)

(72) Inventor: NITHIN VIDYA PRAKASH S, COONOOR (TN)

(21) Appl. No.: 13/789,703

(22) Filed: Mar. 8, 2013

(30) Foreign Application Priority Data
Feb. 5, 2013 (IN) 503/CHE/2013

(51) Int. Cl. G06Q 20/40

(52) U.S. Cl. CPC G06Q 20/40145
USPC 705/18; 705/44

(57) ABSTRACT

In view of the foregoing, an embodiment herein discloses a system and method for facilitating cardless financial transaction in which the face of the user can itself be used as the credit card for financial transaction at the point of sale (POS) or online financial transaction. The method includes capturing a user's face using a 3-D facial recognition system, converting the facial image into digital data and converting the digital data is converted into the numeric template for that user's face and stored in the separate block within the server's database. One aspect discloses a method in which the multiple bank accounts can be managed as single accounts and at the time of cardless financial transaction user may choose which bank account to use which is differentiated by the three digit alphanumeric code assigned for each bank account.

### FIELD OF INVENTION

The embodiments herein generally relate to the field of financial transaction, more specifically, it relates to systems and methods for facilitating secure cardless financial transaction, wherein the users facial biometric information is converted into numerical data and further the numerical data can be converted into credit card number.

### BACKGROUND OF THE INVENTION

A credit card is a payment card issued to users as a system of payment. It allows the cardholder to pay for goods and services based on the card holder's promise to pay for them. The issuer of the card creates a revolving account and grants a line of credit to the consumer (or the user) from which the user can borrow money for payment to a merchant or as a cash advance to the user.

Nowadays, credit card usage has been increased considerably which leads to credit card fraudulent happening in a variety of ways. The most common fraud related to credit card are lost, stolen or theft of credit card which could fall in wrong hands and further may result in hacking and duplicating of the credit card.

The problem with the existing credit card usage is that the credit card holder has to carry the credit card physically and needs to present at the time of making the payment. Most often people handover the credit card for payment of bill at restaurant, filling stations, etc. and the user who takes the credit card from the customer can disappear out of sight for some time before returning with a counterfoil for signature verification. This time can be used for hacking or duplicating the credit card.

Due to increase in credit card usage people may have more than one credit card issued from various banks which can further increase the risk of credit card fraud.

These days many people do most of the shopping and banking on the web and at the time of payment user need to enter their card information such as card number, account number and password which may increase the risk of hacking of users card information.

There are few attempts made in the prior arts to develop a system and method for secure financial transaction, wherein the credit card usage along with the biometric verification at the time of transaction. This method somewhat decreases the fraud related to credit card usage but insufficient to eradicate it completely because the user may also need to present the credit card at the time of financial transaction.

Therefore there is a need to develop a system and method for facilitating secure cardless financial transaction which should allow the user to use his identity itself as a credit card at the time of financial transaction along with some pass codes (pin codes, etc) for double verification of the user.

Further there is a need to develop a system and method for secure cardless financial transaction in which multiple credit card bank accounts can be managed as a single account and the credit card holders facial identity itself can be used instead of credit card at the time of financial transaction and also the multiple banks accounts can be distinguished through separate pin code for each bank account thus avoiding the risk of theft or stolen of the credit card.

Still there is a need to develop a system and method for online financial transaction in which the user's bank account information is not required to enter at the time of payment and user's facial biometric identity can itself be used for the payment along with the pin code.

### OBJECTS OF THE INVENTION

Some of the objects of the present disclosure are described herein below:

The main object of the present invention is to provide a system and method for facilitating secure cardless financial transaction, wherein the facial identify of the user can be assigned as the credit card or credit card number.

Another object of the present invention is to provide a system and method in which the multiple bank card accounts of the user can be managed as a single combined account for cardless financial transaction.

Yet another object of the present invention is to provide an additional security with double verification process for cardless financial transaction.

Still another object of the present invention is to provide a secure cardless online transaction without revealing the user's card account information over the payment engine side on the website.

Still another object of the present invention is to provide a one time registration for assigning credit card number equivalent to the user's face thereby enabling the cardless financial transaction and thus avoiding the chance of lost, theft and misuse of the credit card.

The other objects and advantages of the present invention will be apparent from the following description when read in conjunction with the accompanying drawings which are incorporated for illustration of preferred embodiments of the present invention and are not intended to limit the scope thereof.

### SUMMARY OF THE INVENTION

In view of the foregoing, an embodiment herein discloses a system and method for facilitating cardless financial transaction as well as online cardless financial transaction, wherein the face of the user can itself be assigned as the credit card or more specifically as credit card number for financial transaction. In an embodiment, one time registration process of the user can be done for assigning the credit card number which can include capturing the user facial biometrics by the 3-D facial recognition system. Further the captured image of the user may be processed and converted into primary digital data for further converting into the unique alpha numeric number or numeric number for the user's face. The unique number may be credit card number which is equivalent to the user's face, and can be stored in the separate block in the server's databases. Also, other biometrics (iris scan, body scan, finger print, voice recognition, etc) of the user and the pass codes (pin code, alphanumeric code) defined by the user can be stored as secondary data separately in the server's database for providing double verification and for the additional security.

According to an embodiment, a method for making payment through cardless transaction at the point of sale (POS) is provided, wherein the method includes the step of capturing the facial image of the user using face capturing device and converted it into numeric template. Plurality of input devices can be provided at the point of sale (POS) through which the user can input his other biometric (iris scan, body scan, finger print, voice recognition, etc) data and pass codes (pin code and alphanumeric code). The numeric template along with other biometric, codes may be compared with primary and secondary data stored in the server's data base. If both the compared data matches, then the transaction may proceed and if both the data differs, then the transaction may be denied.

According to an embodiment, a method for making payment through cardless online transaction, wherein a secure connection between the user side and the payment engine side can be established. At the user's side in which the user's facial image may captured along with the other biometric data and the pass codes (pin code or alphanumeric code), which may be compared with the user data stored in the server's database. If both the compared data matches, then the transaction may proceed and if both the data differs, then the transaction may be denied.

According to an embodiment, a system for facilitating cardless financial transaction as well as online cardless financial transaction, wherein the system can include image processing module, face recognition module, conversion module, input module, comparison and verification module, secondary verification module, validation & processing module, server's database module and other modules.

According to an embodiment, multiple bank card accounts of the user can be used as a single combined account from which the user can choose which account to use at the time of financial transaction, which can be differentiated by using three digit alphanumeric codes assigned for each bank account.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures the use of the same reference numbers in different figures indicates similar or identical items.

FIG. 1 illustrates a platform for assigning or generating credit card number, wherein an one time registration process for converting the facial biometrics into credit card number is provided, according to an embodiment herein;

FIG. 2 illustrates a method for cardless transaction at the point of sale (POS), according to an embodiment herein;

FIG. 3 illustrates a method for secure online financial transaction by using the facial information (biometric) as the substitute for credit card number for online payment settlement, according to an embodiment herein; and

FIG. 4 illustrates a system for cardless transaction using facial biometrics of user using facial recognition system, according to an embodiment herein;

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

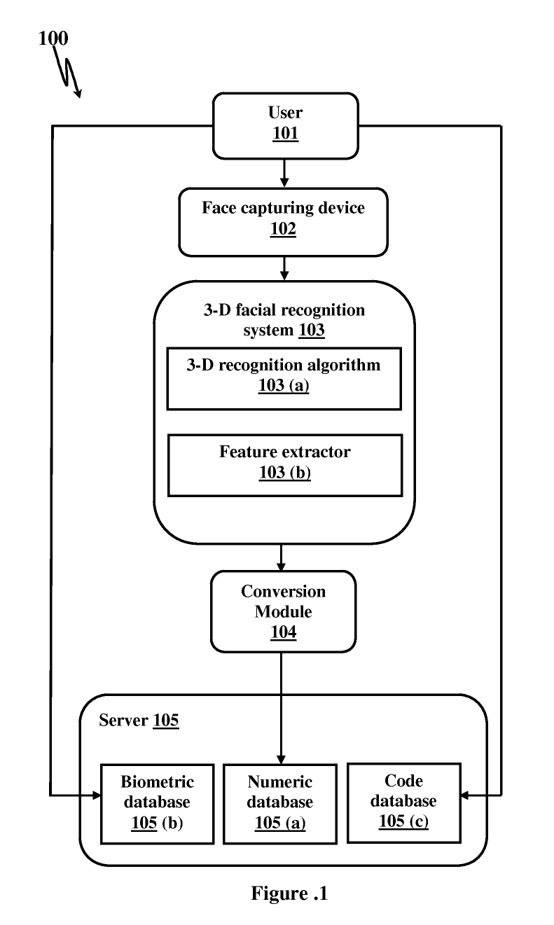

As mentioned, there remains a need for developing a system and method facilitating secure cardless financial transaction, in which face of the user can itself be assigned as the credit card for financial transaction. Referring now to drawings, and more particularly to FIGS. 1 through 4, where similar reference characters denote corresponding features consistently throughout the figures, there are shown preferred embodiments.

According to an embodiment, a system platform 100 for assigning or generating of credit card number respective to user's facial information (biometrics) for facilitating the secure cardless financial transaction is illustrated in FIG. 1. Accordingly, the system platform 100 may include face capturing device 102, conversion module 104, 3-D facial recognition system 103 and server 105. The 3-D facial recognition system may be configured with 3-D recognition algorithm 103 (a) and feature extraction module 103 (b). The server 105 may include various databases which may be numeric database 105 (a), biometric database 105 (b) and code database 105 (c).

In an embodiment, a method for one time registration of the user for assigning or generating the credit card number may include the step of providing face capturing device 102 preferably a digital camera, which can be focused or projected on the user's 101 face for capturing the facial image to send to the 3-D facial recognition system 103. Further the 3-D face recognition system 103 may process the captured 3D image of a user's facial surface. Accordingly, the 3D facial recognition system 103 may use distinctive features of the face where rigid tissue and bone is most apparent, such as the curves of the eye socket, nose and chin to identify the face. These areas are all unique and don't change over time for a user. Further, the 3-D reconstruction algorithm 103 (a) may reconstruct the captured image and further send to the feature extraction module 103 (b), wherein the biometric template may be extracted from the 3-D facial geometry (skull shape, distance between the eyes, width of the nose, depth of the eye socket, etc) and then can be converted into numeric template. The numeric template holding the facial information may further send to the conversion module 104 where the numeric template can be converted into unique number preferably unique credit card number generated for the user. The unique credit card number generated for each face may be stored in the separated database in the server 105.

In an embodiment, the server may include another database referred as biometric database 105 (b) in which other biometric data (iris scan, body scan, finger print reader, voice recognition etc) of the user other than facial information may be stored and can be used for double verification along with the unique credit card number at the time of financial transaction. The server's 105 database further may include code database 105 (c) which may be used to store various security codes which may be preferably pin code, date of birth of the credit card holder, alphanumeric codes, etc for providing additional security at the time of financial transaction along with the credit card number and other biometrics of the credit card holder.

In an embodiment, the code database 105 (c) may be used to store 3 digit alphanumeric code define by the user which can be used as an identifier that can allow the user to maintain multiple bank accounts under one system. The 3 digit alphanumeric code may differ for multiple bank accounts and the user may choose to access the desired bank accounts for cardless financial transaction by entering the 3 digit alphanumeric code assigned for that bank account.

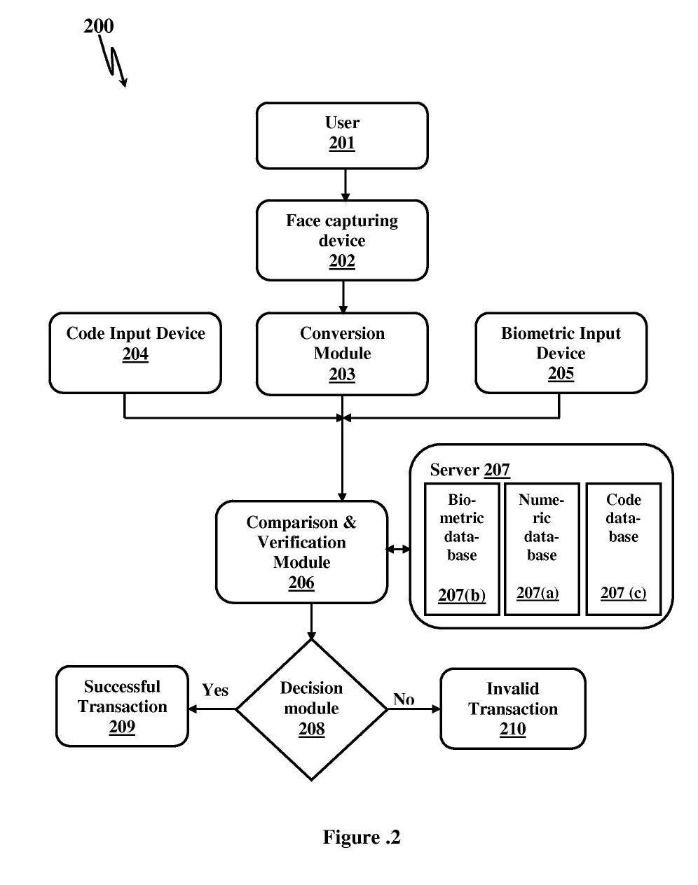

FIG. 2 illustrates a system platform for enabling method involved in cardless transaction at the point of sale (POS) 200, according to an embodiment. Accordingly, the system platform may include face capturing device 202, conversion module 203, code input device 204, biometric input device 205, conversion and verification module 206. The server 207 may include various databases which may be numeric database 207 (a), biometric database 207 (b) and code database 207 (c). Further the decision module 208 may include successful transaction 209 and invalid transaction 210.

In an embodiment, the system platform can enable the method involved in cardless transaction at any point of sale (POS) 200 which may be at the restaurants, shopping centre, etc., According to an embodiment of the present invention, the user can settle the payment without presenting any physical card. The method for cardless payment settlement at the point of sale (POS) may include providing a face capturing device 202 which can be projected at the user's 201 face for capturing the facial image. The captured image of the user 201 may be converted into numerical data by conversion module 203. The numerical data containing the facial biometric information of the user 201 may further send to the comparison and verification module 206. Along with the facial biometrics, there may be the provision for capturing other biometrics of the user like iris scan, body scan, finger print reader, and voice recognition from biometric input device 205 combined with facial recognition for double verification. According to an embodiment, a code input device 204 can be configured with the above system to provide additional security where the user can input the pass code along with the biometrics for payment settlement at the point of sale (POS). The user 201 data from conversion module 203, code input module 204 and biometric input device 205 can be send to the comparison and verification module 206 where each user data may compared with the previously stored user data in server's 207 databases. The server's database 207 can include the numeric database 207 (a) which has the facial biometric of the user inform of numeric data which can be inform of credit card number of the user. The biometric database 207 (b) can include the biometric data of the user other than the facial biometrics. The code database 207 (c) can include the plural pin code of the user along with the 3 digit alphanumeric code for differentiating the different bank accounts. The comparison and verification module 206 may compare the user data from each server's databases. Further, after comparison and verification of the user's data with the server's database it is send to the decision module 208. If the user's data matches with all the data in the server's database, then the decision module 208 can allow the payment (successful transaction 209) and when the user's data does not matches with the server's database, then the decision module denies the payment showing invalid transaction 210.

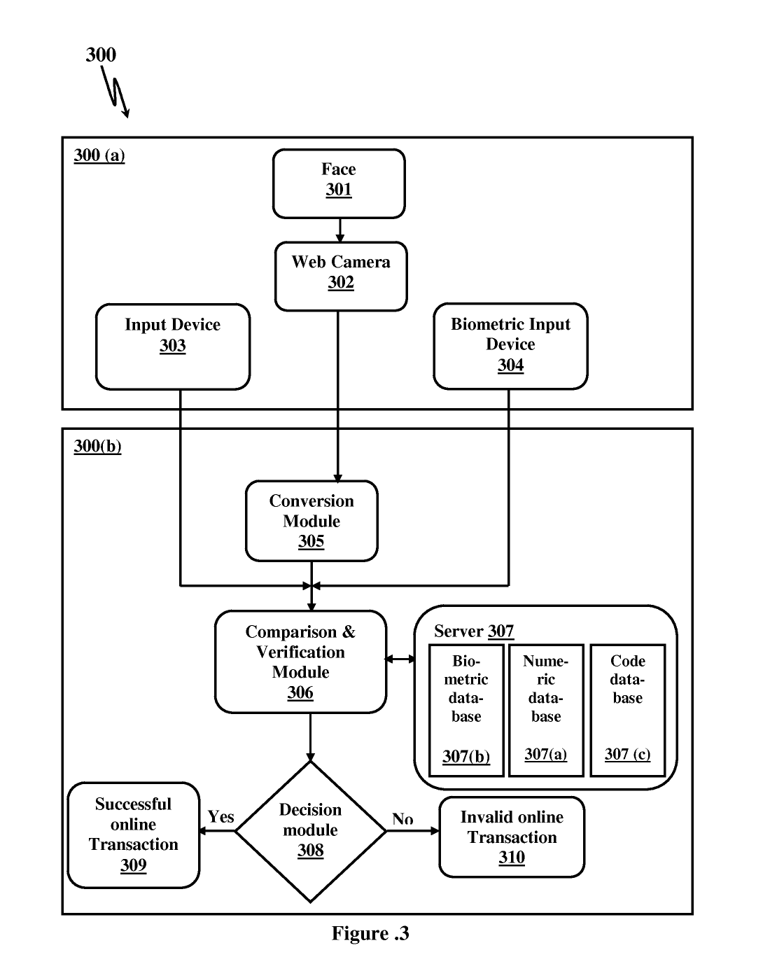

According to an embodiment, a system platform 300 for enabling a method for cardless online financial transaction is illustrated in FIG. 3. Accordingly, the system platform 300 can enable the steps involved in cardless online financial transaction at user's side 300 (a). Further the system platform 300 may include a web camera 302, a code input device 303 and biometric input device 304. Moreover the steps involved in cardless financial transaction at the payment engine side 300 (b) may includes conversion module 305, comparison and verification module 306. The server 307 may include various databases which may be numeric database 307 (a), biometric database 307 (b) and code database 307 (c). In an embodiment, the payment engine side 300 (b) may have the decision module 308 which may show successful online transaction 309 and invalid online transaction 310.

In an embodiment, a method involved in cardless financial transaction at the user's side 300 (a) may include providing a web camera 302 which is an integral part of the computer system. The user who needs to make payment for online shopping, payment of the bills and other online banking transaction can be provided with the option of facial payment mode. As the user or buyer chooses the facial payment mode for payment settlement, the web camera 302 can start and project on the user face to capture the facial biometrics of the user and send it to the conversion module where the facial biometrics of the user is converted into numerical data. Further the user can provide pin code or other security code through input device 302 which may be keyboard of the computer system. Also, there may be a provision of biometric input device 304 through which the user can input his/her biometrics other than the facial biometrics for double verification and additional security of the cardless online financial transaction. Further the user's biometric data are send to the payment engine side 300 (b) in the comparison and verification module 306. Further the comparison and verification module 306 can compare the user data from each stored server's databases. Further, after comparison and verification of the user's data with the server's database, the combined data may send to the decision module 308. If the user's data matches with all the data in the server's database, then the decision module 208 can allow the online payment (successful online transaction 309) and when the user's data does not matches with the server's database, then the decision module can deny the payment showing invalid online transaction 310.

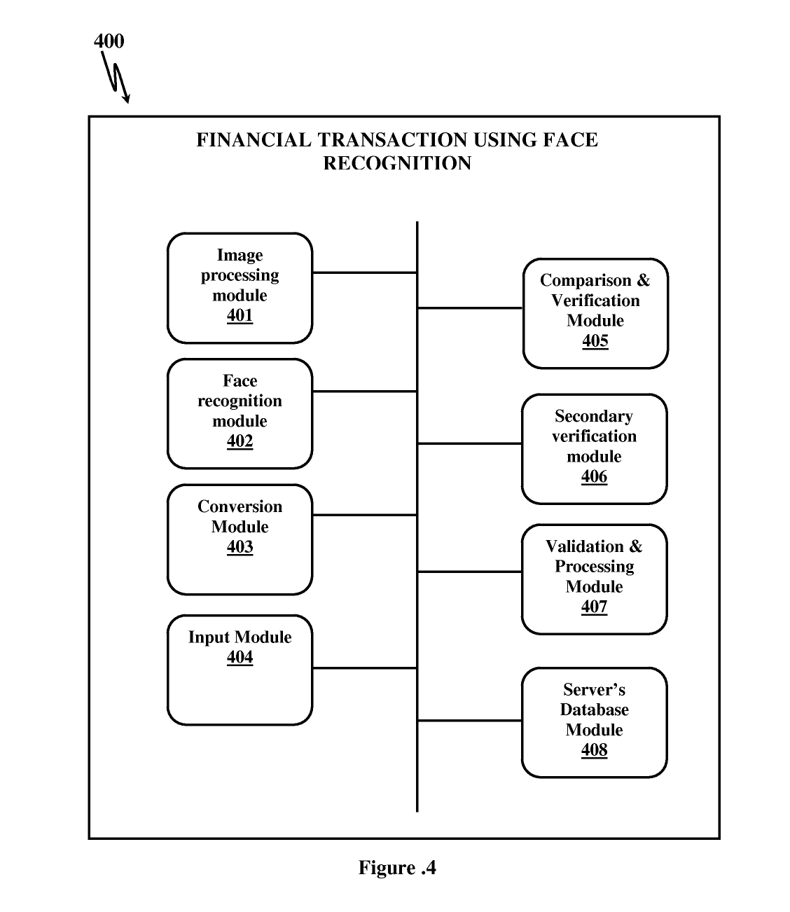

FIG. 4 illustrates a system for facilitating the financial transaction using the facial recognition system 400, wherein the system may include an image processing module 401, face recognition module 402, conversion module 403, input module 404, comparison and verification module 405, secondary verification module 406, validation and processing module 407, and server's databases module 408 and other modules.

In an embodiment, the image processing module 401 can be configured to capture the facial image of the user in front of the face capturing device which may be preferably the camera and converts it into the digital image through analog to digital converter.

In an embodiment, the face recognition module 402 can be configured to use distinctive features of the face where rigid tissue and bone is most apparent, such as the curves of the eye socket, nose and chin to identify the facial biometrics. These areas are all unique and don't change over time. These all facial biometric are converted into the digital data.

In an embodiment, the conversion module 403 can be configured to convert the digital data of the facial biometrics into the numerical template which can be used as the credit card number for the user's face.

In an embodiment, the input module 404 can be configured to provide the user various pass codes (pin code and 3 digit alphanumeric codes) and biometric input along with the facial biometric for double verification and additional security for facilitating cardless financial transaction.

In an embodiment, the comparison and verification module 405 can be configured to compare the user's data such as user's facial biometrics, other biometrics (iris scan, body scan, finger print reader, voice recognition etc combined with facial recognition) and pass codes (pin code and alphanumeric code) with the user's data stored in the server at the time of registration. Further the user's data extracted at the time of financial transaction is verified with the user's data stored in the server at the time of registration of the user.

Within the comparison and verification module 405, there may be the secondary verification module 406 which can be configured to verify the input given by the user from the input device 303 and biometric input device 304 at the time of financial transaction.

In an embodiment, the validation and processing module 407 can be configured to validate the cardless financial transaction if all the comparison and verification is done. If the user's input data matches with the user's data stored in the server's databases, then a successful transaction is done and if the user's data does not matches with the user's data stored in the server's database, then the transaction fails.

In an embodiment, the server's database module 408 can be configured to store and manage the user's information at the time of registration or issuing of the credit card number. The server's data bases includes numeric database for storing the facial biometric of the user in form of numeric template which can be used as the credit card number at the time of financial transaction. Further it includes biometric databases which store the biometric data of the user other than the facial biometrics. The code database stores the several codes of the user which may be pin code, alphanumeric code, etc.

According to present invention, a main advantage is to provide a cardless financial transaction which allows the face of the user to be used as the credit card.

Another advantage is that it facilitates the user to manage his multiple bank accounts under one single account where the user can choose which account to use and further the multiple bank accounts can be differentiated by assigning 3 digit alphanumeric code for each bank account.

Yet another advantage is that additional security is provided with double verification of the credit card holder at the time of financial transaction is done to ensure the secure cardless financial transaction.

Still another advantage is that it also provides the cardless online transaction which enables the user to do online shopping and perform several online banking transactions without revealing user account information over the website.

Still another advantage is that apart from the financial transaction the present system and method may be further used to eradicate all types of physical cards such as driving license, passport, vehicle registration paper, ration card, etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for facilitating cardless financial transaction comprising the step of
capturing at least an user's face using a 3-D facial recognition system;
converting said user's facial image into primary digital data;
converting said primary digital data is converted into the numeric number for said user's face and
storing said numeric template in a server's database.

2. The method as claimed in claim 1, wherein said numeric number is credit card number.

3. The method as claimed in claim 1 further comprising the step of capturing biometrics data of the user using biometric devices, and storing said biometrics data as secondary data separately in said server's database.

4. The method as claimed in claim 3, wherein making payment through cardless transaction at least a point of sale [POS] comprising the step of
capturing the facial image of said user using facing capturing device;
converting said image into numeric template;
comparing said numeric template and biometrics data with said primary data and secondary data;
proceeding payment transaction if both the compared data matches; and
denying payment transaction if both the compared data mismatches.

5. The method as claimed in claim 3, wherein making online payment through cardless transaction comprising the step of
converting said image into numeric data;
allowing users to input biometrics data using biometric devices;
allowing users to input his passcode using input devices;
comparing said numeric template and biometrics data with said primary data and secondary data;
proceeding payment transaction if both the compared data matches; and
denying payment transaction if both the compared data mismatches.

6. The method as claimed in claim 3, wherein user can use 3 digit alphanumeric code defined by said user for identification of a bank's credit card and allow the user to maintain multiple bank accounts under one system.

7-8. (canceled)
